(19) United States
(12) Patent Application Publication
(10) Pub. No.: US 2009/0164931 A1
(43) Pub. Date: Jun. 25, 2009

(54) Method and Apparatus for Managing Test Result Data Generated by a Semiconductor Test System

(75) Inventor: Todd Ryland Kemmerling, Livermore, CA (US)

Correspondence Address: MOSER IP LAW GROUP / FORMFACTOR, INC., 1030 BROAD STREET, 2ND FLOOR, SHREWSBURY, NJ, 07702, US

(73) Assignee: FORMFACTOR, INC., Livermore, CA (US)

(21) Appl. No.: 11/960,396

(22) Filed: Dec. 19, 2007

(51) Int. Cl. G06F 3/048

(52) U.S. Cl. 715/771

(57) ABSTRACT

Methods, apparatus, and computer readable media for managing test result data generated by a semiconductor test system are described. Examples of the invention can relate to managing test result data generated by a semiconductor test system. In some examples, test result data is obtained from the semiconductor test system responsive to testing of a device under test (DUT). The test result data is processed for storage in a relational database using an interface generated in part based on design information of the DUT.

### BACKGROUND OF THE INVENTION

1. Field of the Invention

Embodiments of the present invention generally relate to semiconductor test systems for testing semiconductor devices and, more specifically, to enhancing the performance of semiconductor test systems.

2. Description of the Related Art

Testing is an important step in the production of semiconductor devices. Typically, partially or fully completed semiconductor devices may be tested by bringing terminals disposed on an upper surface of a device to be tested—also referred to as a device under test (or DUT)—into contact with resilient contact elements, for example, as contained in a probe card assembly, as part of a semiconductor test system (“test system”). Test instruments may be coupled to the probe card assembly to send and receive test signals to and from the DUTs over a set of test channels. A test system controller, such as a computer system, may be coupled to the test instruments to control testing of the DUT.

During testing, a test system may collect results of various tests applied to the DUT and provide test result data that includes such results. Such test result data may be referred to as “datalog” data. Presently, test systems from different manufacturers provide different datalog data. For example, test systems may use proprietary software for producing datalog data. Test systems may use proprietary formats for the datalog data. A standard format for datalog data has emerged, known as the standard test data format (STDF). However, the tools for processing STDF formatted datalog data may be non-standard, proprietary, and generated and maintained by the individual users of the test systems.

Accordingly, there exists a need in the art for a method and apparatus for managing test result data generated by a semiconductor test system that attempts to overcome at least some of the aforementioned deficiencies.

### SUMMARY OF THE INVENTION

Embodiments of the invention can relate to a method of managing test result data generated by a semiconductor test system. In some embodiments, a method can include obtaining test result data from the semiconductor test system responsive to testing of a device under test (DUT); and processing the test result data for storage in a relational database using an interface generated in part based on design information of the DUT.

Embodiments of the invention can relate to an apparatus for managing test result data generated by a semiconductor test system configured for testing of a DUT. In some embodiments, the apparatus can include a computer, coupled to the semiconductor test system, to receive test result data. The computer includes an interface generated in part based on design information of the DUT, the interface configured to obtain the test result data and process the test result data for storage in a relational database.

Embodiments of the invention can relate to a system. In some embodiments, the system can include a semiconductor tester configured to generate test result data responsive to testing a device under test (DUT); and a test system controller, coupled to the semiconductor tester, including: a relational database; and an interface, generated in part based on design information of the DUT, the interface configured to obtain the test result data from the semiconductor tester and process the test result data for storage in the relational database.

Embodiments of the invention can relate to a computer readable medium having instructions stored thereon that, when executed by a processor, cause the processor to perform a method of managing test result data generated by a semiconductor test system. In some embodiments, the instructions can be configured to obtain test result data from the semiconductor test system responsive to testing of a device under test (DUT); and process the test result data for storage in a relational database using an interface generated in part based on design information of the DUT.

### BRIEF DESCRIPTION OF THE DRAWINGS

So that the manner in which features of the various embodiments of the present invention can be understood in detail, a more particular description of the invention, briefly summarized above and described more fully below, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a test system according to some embodiments of the invention;

FIG. 2 is a block diagram depicting a test system controller according to some embodiments of the invention;

FIG. 3 is a flow diagram depicting a method of generating an interface according to some embodiments of the invention;

FIG. 4 is a flow diagram depicting a method of managing test result data produced by a semiconductor test system according to some embodiments of the invention; and

FIG. 5 is a flow diagram depicting a method of processing the test result data according to some embodiments of the invention.

Where possible, identical reference numerals are used herein to designate identical elements that are common to the figures. The images used in the drawings are simplified for illustrative purposes and are not necessarily depicted to scale.

### DETAILED DESCRIPTION

This specification describes exemplary embodiments and applications of the invention. The invention, however, is not limited to these exemplary embodiments and applications or to the manner in which the exemplary embodiments and applications operate or are described herein. Moreover, the Figures may show simplified or partial views, and the dimensions of elements in the Figures may be exaggerated or otherwise not in proportion for clarity. In addition, as the terms “on” and “attached to” are used herein, one object (e.g., a material, a layer, a substrate, etc.) can be “on” or “attached to” another object regardless of whether the one object is directly on or attached to the other object or there are one or more intervening objects between the one object and the other object. Also, directions (e.g., above, below, top, bottom, side, up, down, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

The present invention provides methods, apparatus, and computer readable media for managing test result data generated by a semiconductor test system. The test result data can be captured and processed for storage in a relational database. Thus, the test result data can be accessed and analyzed using any of various commercially available database management tools. The need for generating custom software to process and analyze test result data as output by the semiconductor test system can be avoided. By eliminating the need for such custom software, the cost of producing and operating the semiconductor test system may be reduced.

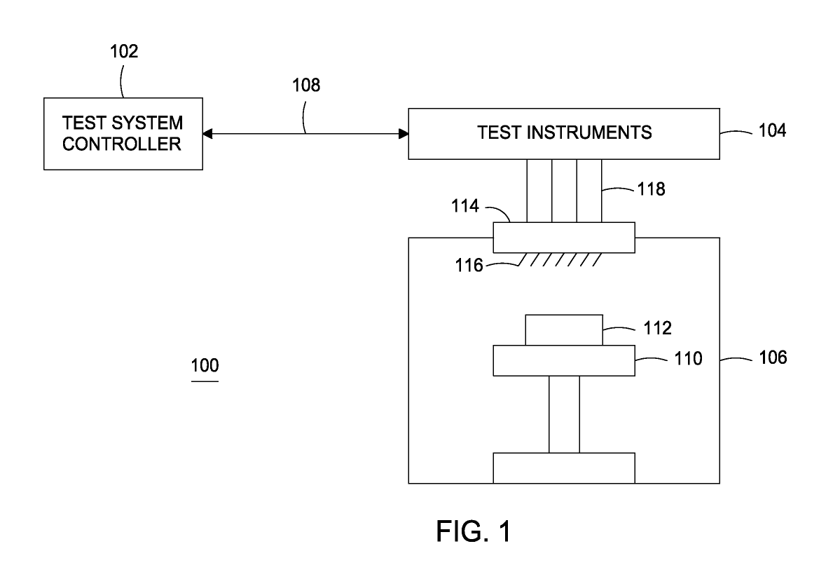

FIG. 1 is a block diagram depicting a test system 100 according to some embodiments of the invention. The test system 100 can generally include a test system controller 102, test instruments 104, a probe card assembly 114, and a prober 106. The test system controller 102 can be coupled to the test instruments 104 by a communication link 108. The prober 106 can include a stage 110 for mounting a device under test (DUT) 112 being tested. The DUT 112 can be any electronic device or devices to be tested. Non-limiting examples of a suitable DUT include one or more dies of an unsingulated semiconductor wafer, one or more semiconductor dies singulated from a wafer (packaged or unpackaged), an array of singulated semiconductor dies disposed in a carrier or other holding device, one or more multi-die electronics modules, one or more printed circuit boards, or any other type of electronic device or devices. The term DUT, as used herein, can refer to one or a plurality of such electronic devices.

The probe card assembly 114 can include probes 116 (also referred to as test probes) that contact the DUT 112. The stage 110 can be movable to contact the DUT 112 with probes 116. The test instruments 104 may be linked by connectors 118 to the probe card assembly 114. The links provided by the connectors 118 can be divided into individual test channels. The test channels may be used to convey test control signals or test signals (including test results). The connectors 118 may be any suitable connectors, such as flexible cable connectors, pogo pins, zero insertion force (ZIF) connectors, or the like. The probe card assembly 114 can fan out one or more of the test channels such that the signal conveyed therein can be coupled to multiple components.

In the test system 100, test data can be generated by the test instruments 104 and transmitted through the probe card assembly 114, the probes 116, and ultimately to the DUT 112. The generation of the test data may be controlled by the test system controller 102. Exemplary embodiments of the test system controller 102 are described below. Test results can then provided from the DUT 112 back through the probe card assembly 114 to the test instruments 104. The test instruments 104 may transmit the test results to the test system controller 102 over the communication link 108 for analysis.

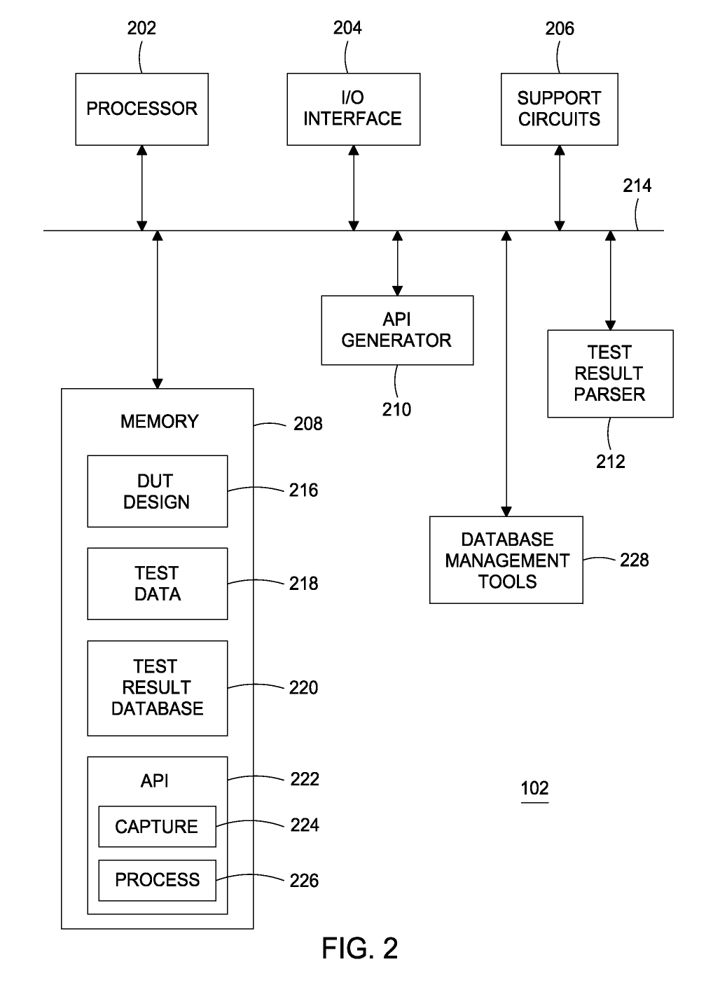

FIG. 2 is a block diagram depicting the test system controller 102 according to some embodiments of the invention. The test system controller 102 may include a processor 202, an input/output (I/O) interface 204, support circuits 206, memory 208, an application programming interface (API) generator 210, and a test result parser 212, each of which is coupled to a communication link 214 (e.g., communication bus(es) or the like). The processor 202 may include one or more microprocessors, microcontrollers, or the like known in the art. The support circuits 206 may include power supplies, clock circuits, data registers, and the like. The memory 208 may include random access memory, read only memory, optical read/write memory, magnetic read/write memory, or the like, as well as various combinations thereof. The I/O interface 204 may include any type of communication interface known in the art or combination of such communication interfaces for facilitating communication between the components in the test system controller 102 (e.g., the processor 202, the memory 208, the API generator 210, the test result parser 212) and the test instruments 104.

The test result parser 212 may receive test result data from the test instruments 104 through the I/O interface 204. The test result data may include a data stream having a sequence of test results having a particular organization (sometimes referred to as the format of the test result data). The test results may include raw and/or derived information collected from the DUT 112 as measured by the prober 106. Raw information may be test results obtained directly from the DUT 112. Derived information may be test results generated in response to signals obtained from the DUT 112. The test results may be organized based on one or more of: lot (e.g., a plurality of wafers), wafer (e.g., a plurality of devices), device (e.g., a test site on a wafer), test applied (a plurality of tests may be applied to each device), or test execution (a test may be executed multiple times). The test result data may also include other information, such as configuration of the test instruments 104, configuration of the probe card assembly 114, configuration of the DUT 112 (e.g., pin information), and the like. In some embodiments, the format of the test result data may be proprietary (e.g., based on manufacturer of the prober 106 and/or test instruments 104). In some embodiments, the format of the test result data may be standardized (e.g., the standard test data format (STDF) discussed above).

The test result parser 212 may capture and process the test result data for storage in a test result database 220, which may be stored in the memory 208. Capturing can involve the extracting of test results and other attributes from the test result data. Processing can involve the formatting and storage of the extracted data in the test result database 220. The test result parser 212 may perform such capturing and processing by executing procedures defined in an application programming interface (API) 222, which may be stored in the memory 208. The API 222 may be generally referred to herein as an interface.

The test result database 220 may be a relational database. In some embodiments, the test result database 220 can store a collection of relations (e.g., tables) that organize the test results from the test result data based on common attributes. For example, the test result database may have a structure of tables, fields in each table, and relationships between fields and tables. The structure of test result database 220 is referred to as a schema. The test result database 220 may be interfaced using a database management language, such as the structured query language (SQL). A database management language, such as SQL, provides a mechanism for creating and defining relations, such as tables, as well as performing operations such as inserting, deleting, querying, and the like.

The API 222 may define one or more procedures for capturing test result data (referred to as a first portion of the API 222 or as capture procedures 224). The test result data may be specific to the design of the DUT being tested, the equipment doing the testing, the tests applied to the DUT, and the like. In addition, the test result data may have a particular format, as discussed above. To capture the test result data, the capture procedures 224 defined by the API 222 can be specifically tailored using the above-described information. In some embodiments, the API 222 includes multiple versions of one or more capture procedures 224 to account for the equipment doing the testing and/or the format of the test result data. For example, there may be a known number of equipment types and/or test result data formats for which the API 222 may account and support. However, there may be a myriad of possible designs for the DUT 112. In addition, there may be a myriad of possible tests applied to the DUT 112. Thus, it would be difficult if not impossible to attempt to provide versions of the capture procedures 224 for each possible DUT design and/or each possible configuration of tests applied to the DUT 112.

Accordingly, in some embodiments, the API generator 210 can generate one or more of the capture procedures 224 using DUT design data 216 as parametric input. The DUT design data 216 may be stored in the memory 208. The DUT design data 216 may include any type of electronic representation of the DUT 112. The API generator 210 can analyze the DUT design data 216 to obtain specific attributes of the DUT 112 that relate to the test result data. For example, the API generator 210 may obtain a configuration of the DUT 112 from the DUT design data 216, such as the number of devices on a wafer, the pin configuration of each device, and the like. The API generator 210 can use the configuration of the DUT 112 from the DUT design data 216 to generate one or more of the capture procedures 224 that are used to capture test results formatted based on such configuration of the DUT 112. In this manner, the API generator 210 can generate one or more of the capture procedures dynamically based on any particular DUT design data. This enables the API 222 to be used with any of a myriad of possible designs for the DUT 112.

In some embodiments, the API generator 210 can generate one or more of the capture procedures 224 using test data 218 as parametric input. The test data 218 may be stored in the memory 208. The test data 218 may include any type of electronic representation of the tests applied to the DUT 112. The API generator 210 can analyze the test data 218 to obtain specific attributes of the tests that relate to the test result data. For example, the API generator 210 may obtain a test configuration from the test data 218, such as the number of tests, the types of tests, the number of times particular tests are executed, and the like. The API generator 210 can use the test configuration in the test data 218 to generate one or more of the capture procedures 224 that are used to capture test results formatted based on such test configuration. In this manner, the API generator 210 can generate one or more of the capture procedures dynamically based on any particular test data. This enables the API 222 to be used with any of a myriad of possible test configurations applied to the DUT 112.

In some embodiments, the API generator 210 can generate one or more of the capture procedures 224 using a combination of the DUT design data 216 and the test data 218.

The API 222 may define one or more procedures for processing captured test result data for storage in the test result database 220 (referred to as a second portion of the API 134 or as processing procedures 226). The processing procedures 226 can be used to establish a schema for the test result database 220. The processing procedures 226 may encapsulate specific database operations (e.g., SQL operations), such as creating relations, inserting and deleting data, querying the relations, and the like.

Accordingly, the test result parser 212 can use the capture procedures 224 defined in the API 222 for capturing the test result data produced by the test instruments 104. The capture procedures 224 may be defined based on the DUT design data 216 for the DUT 112 and/or the test data 218 for the tests applied to the DUT 112. The test result parser 212 can then use the processing procedures 226 defined in the API 222 for storing test results in the test result database 220. Storage of the test result data in the test result database 220 can obviate the need for custom tools to extract and digest the test result data. Relational databases are in wide use in many industries, yielding a variety of commercial database management tools for extraction, reporting, analysis, and the like. For example, the test system controller 102 may include one or more database management tools 228 configured to interact with the test result database 220. For example, the database management tools 228 can be used to query the test result database 220 to produce reports and perform analyses of the test result data stored therein. The database management tools 228 can include any type of commercially available tool capable of managing a relational database. By obviating the need for custom tools to process the test result data, the costs of producing and operating test equipment are reduced.

In some embodiments, the API generator 210 and/or the test result parser 212 comprise modules (e.g., software) having instructions executable by the processor 202. The modules may be stored on computer readable media, which may include information permanently stored on non-writable storage media (e.g., read-only memory devices within a computer such as CD-ROM or DVD-ROM disks readable by a CD-ROM drive or a DVD drive); alterable information stored on writable storage media (e.g., floppy disks within a diskette drive or hard-disk drive or read/writable CD or read/writable DVD); and the like. In other embodiments, the API generator 210 and/or the test result parser 212 may comprise hardware, firmware, software, or some combination thereof. For example, the API generator 210 and/or the test result parser 212 may be implemented using programmable logic devices (PLDs), application specific integrated circuits (ASICs), or the like.

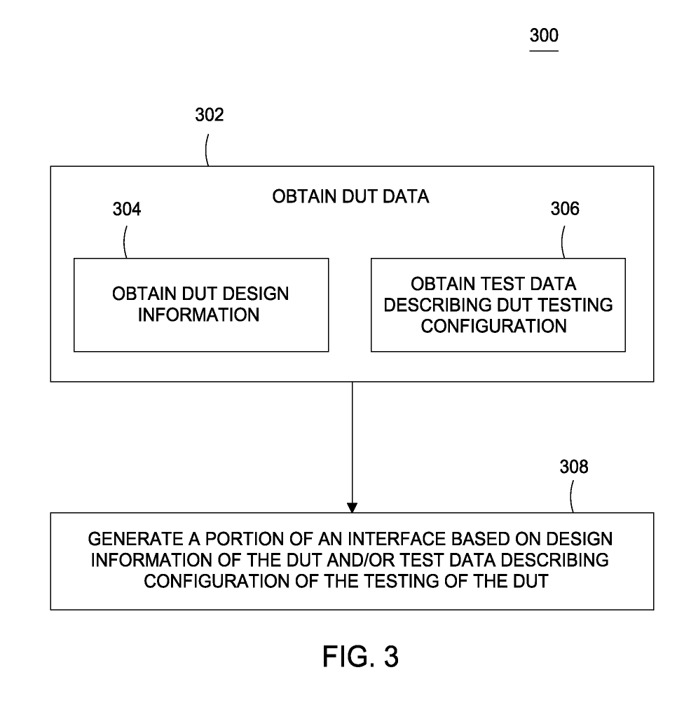

FIG. 3 is a flow diagram depicting a method 300 of generating an interface according to some embodiments of the invention. In the method 300, data associated with the DUT can be obtained (302). In some embodiments, design information of the DUT may be obtained (304). In some embodiments, test data describing configuration of the testing of the DUT can be obtained (306). In some embodiments, both the design information (304) and the test data (306) are obtained. A portion of an interface can be generated based on at least one of: the design information of the DUT or test data describing configuration of the testing of the DUT (308). In some embodiments, the interface may be an API, as described above. The API may include a first portion configured to capture the test result data. The API may include a second portion configured to process the test result data for storage in the relational database. The first portion of the API may be automatically generated in response to the design information of the DUT and/or the test data. The second portion of the API may encapsulate database management language commands.

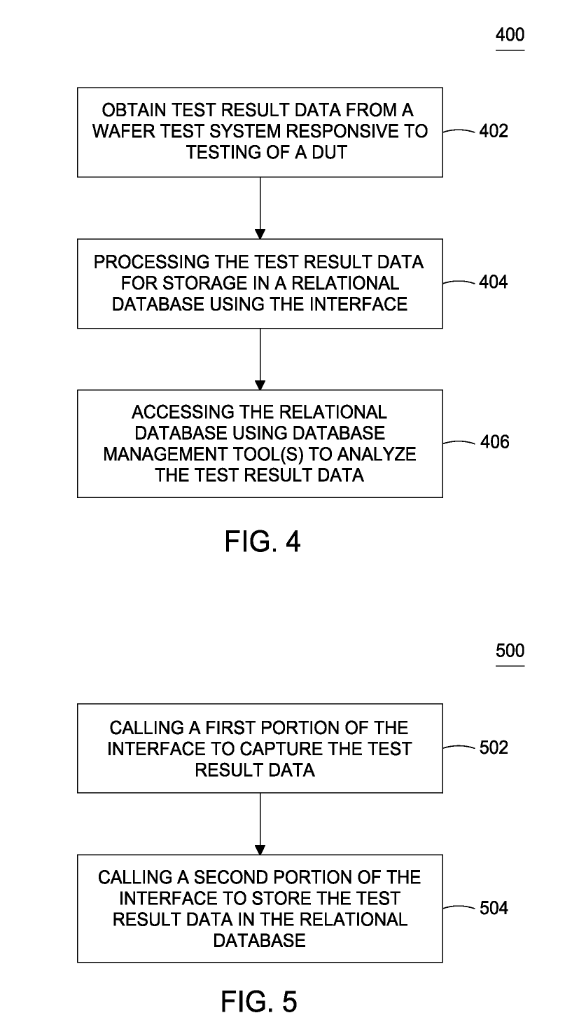

FIG. 4 is a flow diagram depicting a method 400 of managing test result data produced by a semiconductor test system according to some embodiments of the invention. In the method 400, test result data can be obtained from a wafer test system responsive to testing of a DUT (402). The test result data can be processed for storage in a relational database using an interface (306). The interface may be generated as described above in the method 300. The relational database can be accessed using one or more database management tools to analyze the test result data (408).

FIG. 5 is a flow diagram depicting a method 500 of processing the test result data according to some embodiments of the invention. The method 500 may be performed in block 406 of the method 400. In the method 500, a first portion of the interface is called to capture the test result data (502). A second portion of the interface is then called to store the test result data in the relational database (504).

Thus, methods, apparatus, and computer readable media for managing test result data generated by a semiconductor test system have been described herein. The test result data may be obtained from the semiconductor test system responsive to testing of a device under test (DUT). The test result data can be processed for storage in a relational database using an interface generated in part based on design information of the DUT. Since the interface is generated in part based on the design information of the DUT, the interface can be customized for the particular test result data generated by the DUT. Storage of the test result data in a relational database can allow for use of various existing database management tools to analyze the test results, rather than having to produce customized software for performing the same. This can make the test results more portable and accessible, and can reduce the cost of producing and operating the semiconductor test system.

While the foregoing is directed to embodiments of the present invention, other and further embodiments of the invention may be devised without departing from the basic scope thereof, and the scope thereof is determined by the claims that follow.

1. Apparatus for managing test result data generated by a semiconductor test system configured for testing of a device under test (DUT), comprising:
a computer, coupled to the semiconductor test system, to receive test result data, the computer having an interface generated in part based on design information of the DUT, the interface configured to obtain the test result data and process the test result data for storage in a relational database.

2. The apparatus of claim 1, wherein the interface comprises an application programming interface (API) having a first portion configured to capture the test result data.

3. The apparatus of claim 2, wherein the API includes a second portion configured to process the test result data for storage in the relational database.

4. The apparatus of claim 3, wherein the computer comprises:
a test result parser configured to invoke the first portion of the API to obtain the test result data and the second portion of the API to process the test result data for storage in the relational database.

5. The apparatus of claim 4, wherein the computer comprises:
an API generator configured to generate the first portion of the API in response to at least one of: the design information of the DUT or test data describing configuration of the testing of the DUT.

6. The apparatus of claim 3, wherein the second portion of the API encapsulates database management language commands.

7. A system, comprising:
a semiconductor tester configured to generate test result data responsive to testing a device under test (DUT); and
a test system controller, coupled to the semiconductor tester, including:
a relational database; and
an interface, generated in part based on design information of the DUT, the interface configured to obtain the test result data from the semiconductor tester and process the test result data for storage in the relational database.

8. The system of claim 7, wherein the interface comprises an application programming interface (API) having a first portion configured to capture the test result data.

9. The system of claim 8, wherein the API includes a second portion configured to process the test result data for storage in the relational database.

10. The system of claim 9, wherein the test system controller comprises:
a test result parser configured to invoke the first portion of the API to obtain the test result data and the second portion of the API to process the test result data for storage in the relational database.

11. The system of claim 10, wherein the test system controller comprises:
an API generator configured to generate the first portion of the API in response to at least one of: the design information of the DUT or test data describing configuration of the testing of the DUT.

12. A method of managing test result data generated by a semiconductor test system, comprising:
obtaining test result data from the semiconductor test system responsive to testing of a device under test (DUT); and
processing the test result data for storage in a relational database using an interface generated in part based on design information of the DUT.

13. The method of claim 12, further comprising:
accessing the relational database using one or more database management tools to analyze the test result data.

14. The method of claim 12, wherein the interface comprises an application programming interface (API) having a first portion configured to capture the test result data.

15. The method of claim 14, further comprising:
generating the first portion of the API in response to at least one of: the design information of the DUT or test data describing configuration of the testing of the DUT.

16. The method of claim 14, wherein the API includes a second portion configured to process the test result data for storage in the relational database.

17. The method of claim 16, wherein the second portion of the API encapsulates database management language commands.

18. The method of claim 16, wherein the act of processing comprises:
calling the first portion of the API to capture the test result data; and
calling the second portion of the API to store the test result data in the relational database.

19. A computer readable medium having instructions stored thereon that, when executed by a processor, cause the processor to perform a method of managing test result data generated by a semiconductor test system, comprising:
obtaining test result data from the semiconductor test system responsive to testing of a device under test (DUT); and
processing the test result data for storage in a relational database using an interface generated in part based on design information of the DUT.

20. The computer readable medium of claim 19, wherein the interface comprises an application programming interface (API) having a first portion configured to capture the test result data.

21. The computer readable medium of claim 20, further comprising:
generating the first portion of the API in response to at least one of: the design information of the DUT or test data describing configuration of the testing of the DUT.

22. The computer readable medium of claim 20, wherein the API includes a second portion configured to process the test result data for storage in the relational database.

23. The computer readable medium of claim 22, wherein the second portion of the API encapsulates database management language commands.

24. The computer readable medium of claim 22, wherein the act of processing comprises:
calling the first portion of the API to capture the test result data; and
calling the second portion of the API to store the test result data in the relational database.

25-44. (canceled)
